(19) United States
(12) Patent Application Publication
(10) Pub. No.: US 2026/0161698 A1
(43) Pub. Date: Jun. 11, 2026

(54) DYNAMIC DASHBOARD GENERATION USING A LANGUAGE MODEL

(71) Applicant: Stripe Inc., South San Francisco, CA (US)

(72) Inventors: Gautam KEDIA, San Mateo, CA (US); Vinay KUMAR, Fremont, CA (US); Sai Sankalp ARRABOLU, Kenmore, WA (US)

(73) Assignee: Stripe Inc., South San Francisco, CA (US)

(21) Appl. No.: 18/972,771

(22) Filed: Dec. 6, 2024

(51) Int. Cl. G06F 16/438; G06F 16/435

(52) U.S. Cl. CPC G06F 16/438; G06F 16/435

(57) ABSTRACT

A method and related system may generate an interactive dashboard by using a predicted language model context. The method may include generating a context of predicted prompts for a language model and generating queries for execution based on the predicted prompts.

### SUMMARY

Visual display systems and user interfaces may serve as sophisticated control centers that enable operators to monitor real-time equipment status, production metrics, and system anomalies. Such systems can integrate databases and other data stores into meaningful visual summaries. Such systems can form a bridge between human cognition and large quantities of sensor data, other quantitative data, and even non-quantitative data.

Conventional user interface systems that rely on drawing data from databases or other electronic data sources may benefit from the use of a large language model to generate queries from user-provided requests. By properly providing context and application-specific information to a large language model, a computing system may generate queries that can navigate one or more databases to retrieve data and generate reports from that data. However, even in the scenario in which a large language model successfully retrieves report values that are then used to update a dashboard of a visual display system, a user may still have immediate follow-up questions created by one or more issues detected from the report. A significant time lag may be created due to a user's need to first detect these issues, formulate an appropriate prompt to inquire about these issues, resend the new prompt to a large language model, and execute a resulting query generated by this large language model. Such delays may result in errors or even critical system failures.

Some embodiments may overcome these delays without unnecessarily creating additional computing burdens by predicting future user-provided prompts, generating queries based on those predicted prompts, and executing the queries to pre-load reports or report values in memory. After receiving an initial prompt from a user, some embodiments predict future prompts that the user is likely to make and then provide both the initial prompt and predicted prompts to a language model to generate a set of queries. Some embodiments may then execute the set of queries to obtain report values that can then be pre-loaded into memory, where these report values include both values requested by the first prompt and additional report values associated with the predicted prompts.

By pre-loading report values or even entire reports in memory in association with predicted prompts, a computer system may provide real-time or near-real-time responses to user queries. Furthermore, because user-provided prompts and predicted prompts may be evaluated concurrently by a language model, some embodiments may combine queries and reduce the total number of queries needed to provide results for both a user-provided prompt and a set of predicted prompts. Such operations may increase the functionality of a dynamic dashboard that can be interacted with to quickly provide reports that would otherwise require additional processing time to retrieve.

Various other aspects, features, and advantages of the invention will be apparent through the detailed description of the invention and the drawings attached hereto. It is also to be understood that both the foregoing general description and the following detailed description are examples and are not restrictive of the scope of the invention.

### BRIEF DESCRIPTION OF THE DRAWINGS

FIG. 1 shows an illustrative diagram for updating a predictive dashboard or other user interface using a set of predicted follow-up prompts, in accordance with one or more embodiments.

FIG. 2 shows a conceptual diagram of a system to update a predictive dashboard or other user interface, in accordance with one or more embodiments.

FIG. 3 shows a flowchart of a process for updating a predictive dashboard or other user interface using a set of predicted follow-up prompts, in accordance with one or more embodiments.

The technologies described herein will become more apparent to those skilled in the art by studying the detailed description in conjunction with the drawings. Embodiments of implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

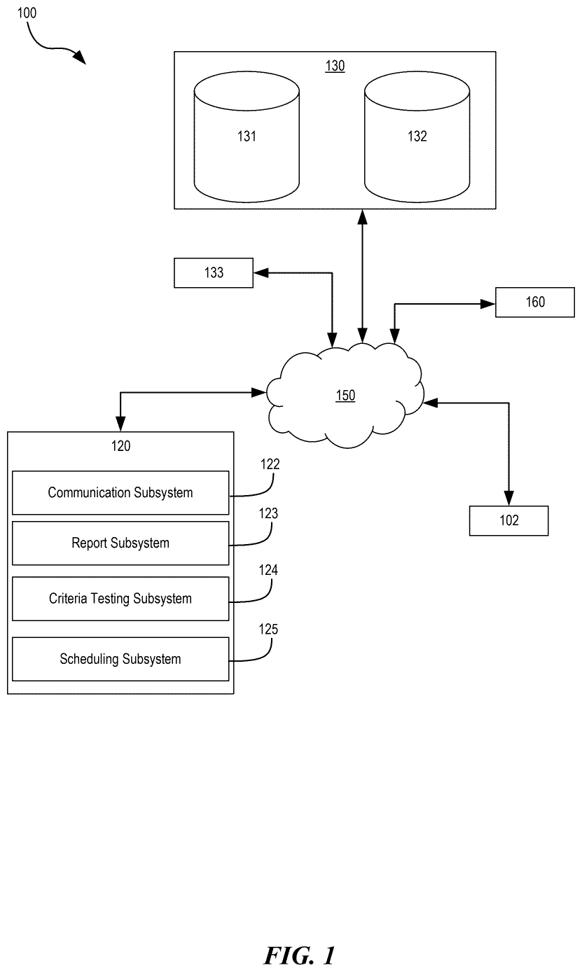

FIG. 1 shows an illustrative diagram for updating a predictive dashboard or other user interface using a set of predicted follow-up prompts, in accordance with one or more embodiments. A system 100 includes a client device 102 in communication with a server 120 via a network 150, where the server 120 may also be in communication with a language model system 160. As will be described further in this disclosure, the server 120 or other computer systems described in this disclosure may perform operations for dynamically updating a predictive dashboard or other user interface using a language model or other model (e.g., another model of similar or high complexity or having similar or high compute costs).

Conventional user interface systems may draw data from databases or other electronic data sources and may benefit from the use of a language model or other model to generate queries from user-provided requests. By properly providing a predicted model context and application-specific information to the model, a computing system may generate queries that can navigate one or more databases to retrieve data and generate reports from that data. However, a user may often have immediate follow-up questions after reviewing a report generated from data retrieved by model-produced queries. Such a request for additional data may require a significant delay due to the need to search a data store with a new query and generate a new report. Such delays may result in unnecessary errors or even critical system failures in various applications. Furthermore, with respect to a language model (or other model with similar or high compute costs), the follow-up question may require a second submission of an input prompt to the language model, thereby increasing a total computational cost.

Some embodiments may perform operations to increase the efficiency of using a language model or another computationally costly model by intelligently predicting a user's request for future reports and using the language model to generate the relevant queries for those reports. In connection with obtaining a first interface interaction that could cause a computer system to generate a report or otherwise update a dashboard or other interface, the system may predict future follow-up interactions likely to follow the first interface interaction. Such operations may permit the system to then combine the user's original prompt with these predicted future prompts into a combined input and use a language model to generate queries for multiple possible requests using the combined input. The system may then use these queries to update a user interface and generate reports requested by the user and reports the user is likely to request in the future. By intelligently predicting future report requests and generating these possible future reports, the system may remove the lag between an initial request for a report and likely follow-up requests the user may have at a later time.

For example, some embodiments, in connection with receiving a user prompt “generate monthly device connectivity report,” a computer system may predict the possible future prompt “generate node failure reports grouped by device connectivity failures.” The computer system may combine these prompts into a single input for a language model for use as part of a predicted context and then produce a set of queries that can efficiently retrieve these report values from a data store while reducing duplicative searches throughout the data store or otherwise reducing network resource consumption. The computer system may aggregate these results into a first set of report values that correspond with the user's original prompt and is presented to the user. Additionally, the computer system may store the other resulting report values in cache in case a user requests a report involving these other report values. In response to obtaining a later request for these other report values (e.g., the user enters “provide me with a node failure report related to the failures”), the computer system may then retrieve these stored report values from the cache and present a report for these requested values without executing a second search.

By using predicted prompts when using a language model to generate queries, some embodiments may provide real-time responsiveness to a user's request for data that would normally require far more time to provide. Furthermore, combining the user-provided prompt with the predicted prompts into a single input for a language model allows a system to obtain queries for different reports in a single use of the language model. Such operations may thereby reduce the total cost of using the language model, reduce the chance of creating duplicative query searches, or otherwise reduce network resource consumption.

The client device 102 may include one of various types of computing devices, such as a laptop, a tablet, a desktop, a payment kiosk, a payment terminal, a smartphone, etc. The client device 102 may send requests, responses, or other messages to the server 120 that may require communication with other computing devices or other electronic devices. Additionally, the server 120 may include various types of computing units, such as physically separate servers, virtual nodes hosted on one or more physical machines, or nodes on a cloud computing system. Applications, services, or other operations may use data provided by the client device 102, the server 120, or a set of databases 130. The set of databases 130 may include various types of databases, such as SQL databases, no SQL databases, graph databases, etc. In some embodiments, the server 120 may perform one or more operations related to a communication subsystem 122, an input generation subsystem 123, language model subsystem 124, or a report value management subsystem 125.

In some embodiments, the communication subsystem 122 may obtain program instructions, report values, commands, queries, parameters, values, or other data from the client device 102 that may cause the retrieval of data for generating or updating interactive audio/visual dashboard content or other content for presentation on a user interface. Furthermore, operations performed by the server 120 may use the communication subsystem 122 to send messages to the set of databases 130, the client device 102, the language model system 160, or another computing device described in this disclosure. For example, the communication subsystem 122 may receive a user-provided text sequence or another type of user-provided prompt that the server 120 would use to predict a future context. The communication subsystem 122 may then present content (e.g., interactive audio/visual dashboard content or other content), which may be dynamically updated using report values that are generated based on the predicted context.

In some embodiments, the input generation subsystem 123 may use data obtained using the communication subsystem 122 or another portion of the server 120 to generate a model input for a language model. In some embodiments, the input generation subsystem 123 may generate an input that includes a user-provided prompt, such as a user-provided text sequence obtained from a client device, The input may also include a predicted language model context that includes a set of follow-up text sequences or another type of follow-up prompts, where the follow-up text sequences or prompts represent anticipated future prompts. Some embodiments may generate the anticipated future prompt by using a prompt prediction model as a preliminary prediction model. For example, some embodiments may provide the preliminary prediction model with an initial user-provided prompt, where the preliminary prediction model then uses a rules-based method to select future prompts based on matching keywords, key phrases, or some other set of sequences of text. It should be understood that the preliminary prediction model may use other methods of predicting prompts, such as statistical methods or machine-learning methods.

In some embodiments, the language model subsystem 124 may send an input generated by the input generation subsystem 123 or another candidate input to a language model, such as the language model system 160 to obtain an output set of queries. For example, the language model subsystem 124 may send a model input that includes a user-provided prompt and three predicted prompts to a language model system 160. The language model system 160 may then output a set of queries to retrieve data that would provide data both on the user-provided prompt and the three predicted prompts. In some embodiments, the language model system 160 may detect duplicative requests between the input prompts and generate more efficient queries. For example, the first prompt may be “How many requests has each application requested?” and a predicted prompt may be “What's the average memory amount requested by each application?” Some embodiments may use the natural language model to combine the queries for these two prompts into a single query so that the number of applications is only required to be looked up once and only one matching operation between applications and requests is needed.

In some embodiments, the language model subsystem 124 may generate a set of predicted prompts based on the data retrieved from the set of databases 130. In some embodiments, data retrieved from the set of databases 130 may cause a user to have additional questions or request new reports. Some embodiments may take advantage of historical behavior patterns based on the relationship with reported values and these later-provided prompts. Some embodiments may provide reported values from the set of databases 130 or another set of data sources to a machine learning model to generate or otherwise provide a set of predicted prompts. For example, some embodiments may provide reported values from the set of databases 130 to a transformer-based neural network model to generate a set of predicted prompts. In some embodiments, the transformer-based neural network model may also receive, as part of the input (e.g., as part of an input context of the input) one or more previously used or generated prompts, one or more previously used or generated queries, etc. Some embodiments may further take advantage of the distributed nature of distributed databases. For example, some embodiments may retrieve data from a first database 131 of the set of databases 130 based on a determination that the first database 131 or a portion of the first database 131 is associated with a profile of the user or maps to a category assigned to the user. Similarly, some embodiments may retrieve data from a second database 132 of the set of databases 130 based on a determination that the second database 132 or a portion of the second database 132 is associated with the profile of the user or maps to a category assigned to the user.

In some embodiments, the report value management subsystem 125 may execute generated queries to retrieve a set of report values, store the set of report values in a cache, and quickly retrieve them to enable the predictive and dynamic aspects of audio/visual dashboard content or other content for presentation on a user interface. Some embodiments may retrieve both a first set of values retrieved based on a user prompt and retrieve a second set of values based on one or more predicted prompts. Some embodiments may provide the user prompt data directly to the client device 102 while storing the second set of data in a cache memory 133.

Some embodiments then receive a second request for data from the client device 102. For example, as described elsewhere in this disclosure, some embodiments may retrieve first reporting values that directly provide the requested information for a first prompt and retrieve second reporting values that provide additional information that would be responsive to a predicted prompt. Some embodiments may compare the text of the second request with the predicted prompts and, based on a determination that the second request sufficiently matches the predicted prompt, retrieve the second report values corresponding with the predicted prompt. Two texts may sufficiently match based on a set of matching criteria. For example, some embodiments may determine that the patterns (e.g., regular expression patterns) derived from two prompts are the same and, in response, determine that the two prompts sufficiently match. Alternatively, or additionally, some embodiments may determine that embedding vectors generated from a pair of prompts are sufficiently similar and determine that the pair of prompts satisfy a set of matching criteria and thus sufficiently match. Based on a determination that a predicted prompt sufficiently matches a second prompt, some embodiments may display the report values retrieved based on the predicted prompt from a memory, such as a cache memory (e.g., a cache memory 133) or the memory of a client device (e.g., a local memory of the client device 102).

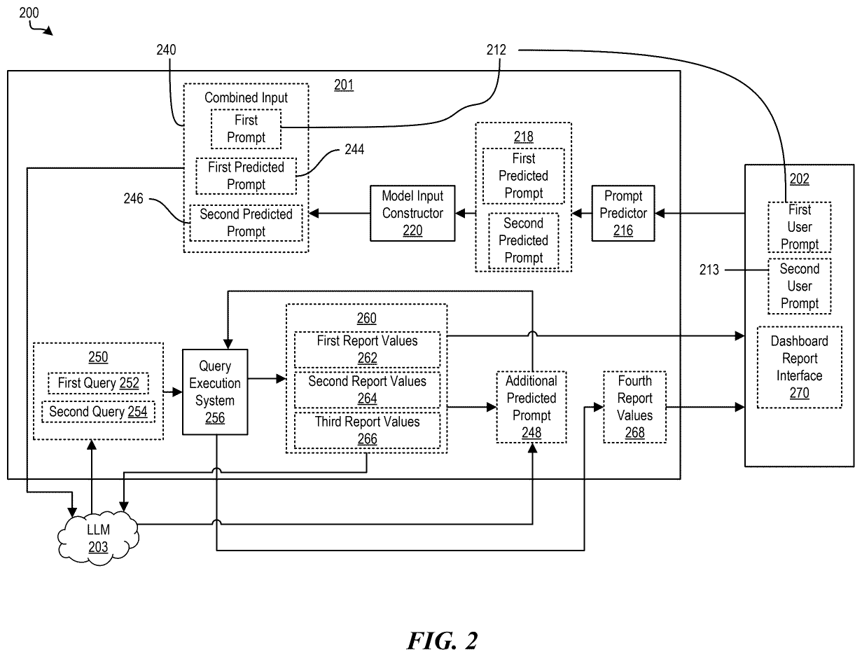

FIG. 2 shows a conceptual diagram of a system to update a predictive dashboard or other user interface, in accordance with one or more embodiments. In some embodiments, the system 200 depicts a server system 201, a client device 202, and a language model system 203. In some embodiments, the server system 201 may or may not include a physical server (e.g., an on-premises server). Alternatively, or additionally, the server system 201 may or may not include a cloud server (e.g., as a virtual machine, as a cloud instance, as a cluster).

In some embodiments, the client device 202 may provide a first prompt 212 to a prompt predictor 216. The prompt predictor 216 may include at least one of a rules-based prediction subsystem, a statistical prediction subsystem, or a machine learning prediction subsystem. The prompt predictor 216 may output a set of follow-up prompts 218. In some embodiments, when generating one or more follow-up prompts, the prompt predictor 216 may consider other information such as a user profile, a history of the user's behavior, a history of other users having profiles similar to the user, etc. In some embodiments, a model input constructor 220 being executed by the server system 201 may output a combined input 240, where the combined input 240 includes a version of the first prompt 212, a first predicted prompt 244, a second predicted prompt 246, where the first predicted prompt 244 and the second predicted prompt 246 may be selected from the set of follow-up prompts 218.

The server system 201 may then provide the combined input 240 to the language model system 203. After receiving the combined input 240 as an input, some embodiments may output a set of output queries 250 that includes a first query 252 and a second query 254. In some embodiments, the first query 252 may be generated based on the first prompt 212 and the first predicted prompt 244, and the second query 254 may be generated based on the second predicted prompt 246. In some embodiments, the language model system 203 may determine that the first prompt 212 and the first predicted prompt 244 may be combined into a single query for more efficient retrieval.

In some embodiments, a query execution system 256 executes the set of output queries 250 to obtain a set of report values 260. The set of report values 260 includes first report values 262 corresponding with the first prompt 212, second report values 264 corresponding with the first predicted prompt 244, and third report values 266 corresponding with the second predicted prompt 246. Some embodiments may provide the first report values 262 to the client device 202 while retaining the second report values 264 and the third report values 266 in a cache memory to enable fast retrieval.

Some embodiments may provide one or more values of the set of report values 260 back to the language model system 203, where the language model system 203 may output an additional predicted prompt 248. Some embodiments may then provide the additional predicted prompt 248 to the query execution system 256 to obtain fourth report values 268. By using report values as additional inputs for prompt generation, some embodiments may be able to initialize operations to produce additional likely reports that a user may request based on specific anomalies or other issues detected in the set of report values 260. For example, some embodiments may detect that one or more sets of report values of the set of report values 260 exceeds a maximum threshold or is below a minimum threshold and, in response. In response, the server system 201 may send the set of report values 260 to the language model system 203. It should be understood that some embodiments may send the first report values 262 the language model system 203 without applying any threshold or other criteria.

While the system 200 shows the use of a single language model system, it should be understood that multiple language model systems may be used. For example, some embodiments may send the first report values 262 to a different language model than the language model system 203 to obtain the additional predicted prompt 248. Furthermore, it should be understood that some embodiments may include an alternative language model system that performs some or all of the operations described as being performed by the language model system 203, where the alternative language model system may be a part of the server system 201.

In some embodiments, the client device 202 may receive the first report values 262 from the server system 201 and display a dashboard report in a dashboard report interface 270 or otherwise update a rendering of the dashboard report interface 270. Furthermore, the server system 201 may receive a second user prompt 213 and compare the second user prompt 213 with the first predicted prompt 244, the second predicted prompt 246, and the additional predicted prompt 248. In response to a determination that the second user prompt 213 is sufficiently similar to at least one of these prompts, some embodiments may retrieve the corresponding report values to send to the client device 202. For example, some embodiments may generate a first set of semantic vectors by providing the second user prompt 213 to a neural network and generate a second set of semantic vectors by providing the first predicted prompt 244 to the neural network. Some embodiments may determine whether the first and second sets of semantic vectors are sufficiently close within the vector space. Based on the determination that the two sets of vectors are sufficiently close (e.g., within a vector space distance threshold using a Euclidean distance metric, a cosine distance metric, etc.), some embodiments may retrieve the corresponding report values to send to the client device 202. For example, the server system 201 may determine that the second user prompt 213 is sufficiently similar to the second predicted prompt 246 and, in response, retrieve the second report values 264 from a cache memory. The server system 201 may then send the second report values 264 to the client device 202 so that the second report values 264 may be displayed on the dashboard report interface 270 or otherwise modify a rendering of the dashboard report interface 270.

In some embodiments, the server system 201 may send report values directly to the client device 202 as an alternative to or in addition to storing report values in a cache memory. In such cases, the client device 202 may directly determine that the second user prompt 213 sufficiently matches with another predicted query and, in response, retrieve a set of report values corresponding with the predicted query from local memory. The client device 202 may then use the set of report values retrieved from local memory in the dashboard report interface 270.

### Flowchart

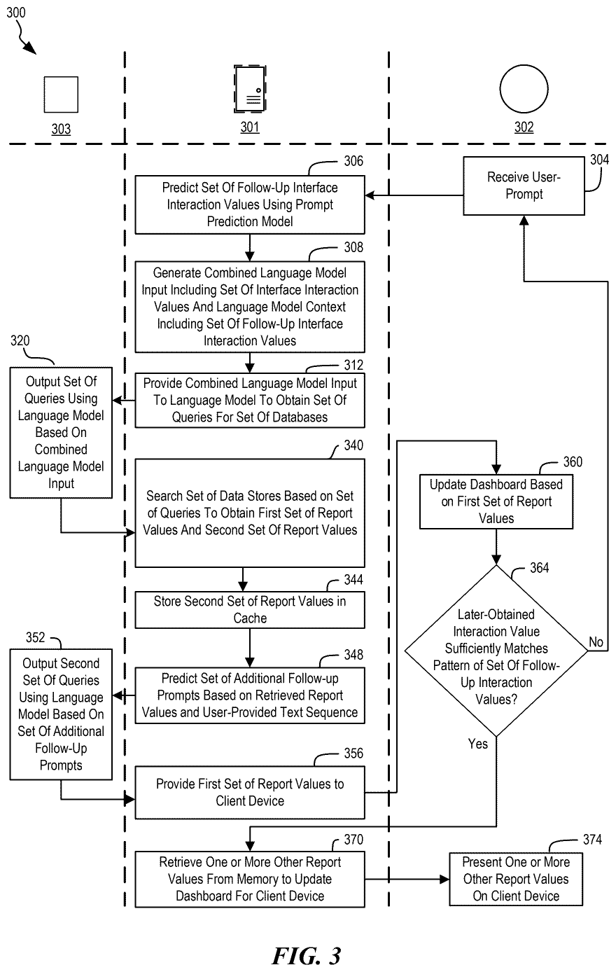

FIG. 3 shows a flowchart of a process for updating a predictive dashboard or other user interface using a set of predicted follow-up prompts, in accordance with one or more embodiments. The process 300 is shown as a flowchart, in which a column 301 represents operations performed by a server system, column 302 represents operations performed by a client system, and column 303 represents operations performed by a large language model system. It should be understood that descriptions of an operation being performed by a system are exemplary and non-limiting, such that operations described as being performed by one system may instead be performed by another system unless described otherwise. For example, one or more operations described for block 344 as being performed by a server system may instead or also be performed by a client system.

Some embodiments may receive a user-provided text sequence as a prompt, as indicated by block 304. In some embodiments, operations for the block 304 may be performed by a client system, as indicated by column 302. In some embodiments, a user-provided text input or other user-provided prompt may be received at a client system, such as a client mobile computing device, laptop, or other client device. In some embodiments, a user-related text sequence may be received via a UI screen displaying a dashboard that includes one or more UI elements in which a user may provide a prompt. The user-provided prompt may include a user-provided text sequence that includes natural language instructions to a computer system to perform one or more report-generation operations. Alternatively, or additionally, a user may provide other data in a prompt, such as image data, audio data, or video data. Some embodiments may perform operations to process visual data to recognize one or more objects or processed audio data to perform transcription or sound identification operations.

Some embodiments may predict a set of follow-up interface interaction values by using a prompt prediction model, as indicated by block 306. In some embodiments, operations for the block 306 may be performed by a server system, as indicated by column 301. In some embodiments, the set of follow-up interface interaction values may include a set of follow-up text sequences, a set of user interactions with UI elements, other types of prompts (e.g., image data, audio data, etc.), a specific sequence of user interactions, etc. For example, some embodiments may predict a set of follow-up text sequences by providing the user-provided text sequence to a prompt prediction model. For example, a server system may perform operations to predict a set of follow-up prompts, such as a set of follow-up text sequences. As described elsewhere in this disclosure, some embodiments may use a prompt prediction model to predict a set of follow-up prompts representing one or more anticipated input text or other types of anticipated future prompts from a user. a user is likely to provide one or more follow-up prompts after receiving a response to a first prompt.

Some embodiments may train a prompt prediction model as a preliminary prediction model to predict one or more of these follow-up prompts from a user after the user provides a first prompt. Some embodiments may then use the prompt prediction model to predict one or more future prompts that a user may provide. For example, after receiving a user-provided prompt “tell me my infrastructure performance over the last three months,” some embodiments may provide the user-provided prompt to a preliminary prediction model that outputs predictions of follow-up prompts. The preliminary prediction model may then output a first follow-up prompt that recites “what are common features shared by the failing nodes” and a second follow-up prompt that recites “what is the cost in the impact on infrastructure performance.” As described elsewhere in this disclosure, some embodiments may send to a large language model described in this disclosure, these additional prompts in a single pass.

Some embodiments may predict only a single prompt for use as a predicted follow-up prompt. Alternatively, some embodiments may predict multiple prompts for use as a set of predicted follow-up prompts. For example, some embodiments may predict that a user has of a likelihood of entering at least one text sequence of two different text sequences. Moreover, some embodiments may be configured to provide a default number of predicted prompts. For example, some embodiments use a prompt prediction model that outputs the top three most likely follow-up prompts that a user is likely to enter after a first user-provided prompt. Alternatively, some embodiments may be configured to provide a variable number of predicted prompts based on a determination of likelihoods associated with the predicted prompts. For example, some embodiments use a prompt prediction model that outputs a respective follow-up prompt of a set of follow-up prompts so long as the likelihood score of the respective follow-up prompt computed by the prediction model satisfies a minimum likelihood threshold.

In some embodiments, some embodiments may train a prompt prediction model with a prompt prediction model training data set. A prompt prediction model training data set may include, for each respective user of a set of users, an initial user-provided prompt and a respective set of follow-up prompts. Some embodiments may use a user-specific prompt prediction model when generating one or more predicted prompts. For example, some embodiments may train a machine learning model for use by a first user by using a user-specific training model data set that includes the initial user-provided prompts of the first user and the follow-up prompts provided by that first user. Some embodiments may then store the model parameter values characterizing this user-specific machine learning model in a user profile record associated with the first user, where the model parameter values may include weights, biases, activation function values, other neural unit function parameters, etc. For example, after receiving an initial prompt from the first user at a later time during a later data session between a client device and a server system, some embodiments may then retrieve the model parameters stored in the user profile record of the first user. Some embodiments may then configure one or more model parameters of the prompt prediction model or other preliminary prediction model with the model parameter values retrieved from the user profile record.

Some embodiments may generate a combined language model input that includes a set of user interaction values and a language model context, the language model context including the set of follow-up interface interaction values, as indicated by block 308. In some embodiments, operations for the block 308 may be performed by a server system, as indicated by column 301.

In some embodiments, the set of user interface interaction values may include user-provided text, image data, audio data, a sequence of user interactions with a user interface, etc. For example, some embodiments may generate a combined language model input that includes user-provided text sequence and a predicted language model context that includes a set of predicted interface interaction values. For example, in some embodiments, the predicted language model context includes a set of follow-up text sequences. Some embodiments may prepare an input context for a large language model that includes a predicted set of follow-up prompts, such as a set of follow-up text sequences or other follow-up data. For example, after receiving a user-provided prompt “run report 01” and providing the user-provided prompt to a prompt prediction model to obtain a first follow-up prompt “run sub-report XY” and a second follow-up prompt “run sub-report ZZ.” Some embodiments may then prepare a combined language model input that includes the user-provided prompt and a language model context, where the language model context includes the first follow-up prompt and the second follow-up prompt.

In some embodiments, the language model context or another portion of a combined language model input for a language model may include additional information. For example, some embodiments may indicate a likelihood associated with one or more of the follow-up prompts, where the likelihood indicates a likelihood that a user is going to provide the follow-up prompt. Some embodiments may then use this associated set of likelihood scores to determine downstream operations, such as whether to perform a search or store data based on an available memory amount, an available processor resource amount, or another computing resource.

Some embodiments may separate the different follow-up prompts from each other using one or more types of delimiters. For example, some embodiments may use a delimiter “###” to separate each respective text sequence of a plurality of follow-up text sequences from other text sequences of the plurality of follow-up text sequences. Various other types of delimiters may be used, where a delimiter may include one or more symbols, alphanumeric characters, spaces, punctuation, or some combination thereof. Some embodiments may use different delimiters to indicate different information associated with a prompt, such as a priority level, a relation with a set of reporting values, etc.

In some embodiments, the language model context or another portion of a combined language model input may include instructions to generate a query, generate program code, or generate a set of computer-readable instructions. For example, some embodiments may update a combined language model input to include the first phrase, “generate a set of SQL queries to accomplish the following instructions.” Furthermore, some embodiments may perform error-checking or de-duplication operations that prevent one or more default phrases from being used if certain criteria are satisfied. For example, some embodiments may forgo sending the first phrase based on a determination that the original user-provided prompt includes the phrase “set of SQL queries.”

Some embodiments may generate a combined language model input that results in a language model outputting a cross-database query. For example, some embodiments may detect that a set of user-provided prompts or set of predicted follow-up prompts is associated with one or more columns of a set of databases. Some embodiments may then generate a combined language model input that indicates the set of databases and their corresponding columns. In the case where the set of databases includes multiple databases, or even multiple data systems, a language model may then generate a cross-database query that would be applied to these multiple databases or data systems across different computing clusters.

Some embodiments may provide, to a large language model, the combined model language input to obtain a set of queries for a set of databases, as indicated by block 312. In some embodiments, operations for the block 312 may be performed by a server system, as indicated by column 301. Some embodiments may use a large language model stored or operated by a different server system or external computing system. For example, some embodiments may send, via a network, an HTTP request that includes the combined language model input to a large language model application programming interface endpoint. The network application programming interface may send the combined language model input as a series of HTTP messages or other messages written in other protocols. Furthermore, some embodiments may send configuration parameters for a language model, such as a model temperature, a maximum number of tokens to accept, a model name for a specific language model to be used, etc.

In some embodiments, the combined language model input may be further modified based on a specific language model type to be selected. Furthermore, some embodiments may assign certain portions of the input language model context (e.g., predicted queries) with ranking scores. Some embodiments may provide such a ranking in the input context of a language model input to provide the language model with the opportunity to sort the importance of predicted prompts when generating queries or other outputs for a predicted prompt. For example, some embodiments may provide a ranking indicating a likelihood of a predicted follow-up prompt being entered by a user, where the ranking may be a probability value, a numeric integer ranking or another type of indicator of an ordered sequence, a categorical value, etc. Some embodiments may use a set of rankings representing an associated set of likelihood scores for a set of queries to prioritize search operations or data storage operations based on an available memory amount or a server system or other computing resource of the server system or another computing system. Alternatively, or additionally, some embodiments may send additional information or metadata in association with an input for a language model indicating priorities associated with one or more prompts.

In some embodiments, the combined model language input may be sent in a framework that permits multiple agents to operate, where a combined model language input may include one or more prompts that are designated for an external agent that may or may not include a language model. For example, some embodiments may generate a combined model language input that includes a context having a first prompt and a second prompt. Some embodiments may send the combined model language input to a first end point that performs operations to route some or all of the combined model language input to multiple independent agents, where the first prompt is routed to a first external agent that includes a first language model, and where the second prompt is routed to a second external agent that includes a second language model. As described elsewhere in this disclosure, some embodiments may receive an external agent-provided output from an external agent based on prompts provided to the external agent and use the external agent-provided output as part of a set of report values or to otherwise configure a user interface.

In some embodiments, a language model may output a set of queries based on the combined language model input, as indicated by block 320. In some embodiments, operations for the block 320 may be performed by a large language model system, as indicated by column 303. In some embodiments, the format for the set of queries may be explicitly provided in a user prompt. For example, a user-provided query may include an explicit instruction to provide SQL queries or graphQL queries. Alternatively, as described elsewhere in this disclosure, some embodiments may augment user-provided prompts with additional instructions to indicate one or more query languages or formats to use. Furthermore, as described elsewhere in this disclosure, some embodiments may use a language model that has been specially configured to provide queries in one or more specified languages or formats. Furthermore, as described elsewhere in this disclosure, some embodiments may generate a cross-database query that may cause a system to search through multiple databases or even multiple data systems across different computing clusters.

As described elsewhere, some embodiments may reduce the amount of network resources being used or the amount of computing resources being used by consolidating a user-provided prompt and one or more follow-up prompts predicted to be later provided by the user. By sending sets of text sequences representing prompts in a single message or in a single pass through a network, some embodiments may more efficiently use the computing resources provided to a large language model. Furthermore, sending messages in a single pass decreases the likelihood that a network interruption may prevent one or more portions of a prompt from reaching a language model and creating inaccurate results.

As described elsewhere in this disclosure, some embodiments may provide prompts to an external agent that directly provides one or more report values used to configure a dashboard element or other user interface element. For example, some embodiments may provide a first prompt “give me daily parking data in parking lot LOT1” to an external agent connected to parking infrastructure sensors in the parking lot LOT1. The external agent may then provide an output, where the external agent-provided output may include values indicating the occupancy of the parking lot over the course of a day. Some embodiments may then use these values as a set of agent-provided report values when generating or updating a dashboard data table. For example, if an agent provides an external agent-provided output equal to “85%,” some embodiments may receive this output and use it as an agent-provided report value to change the display of a dashboard element to show “85%.”In some embodiments, the other context may be stripped from an input for an external agent. Some embodiments may strip the context from the input if this context is not necessary or would reduce the accuracy of agent-provided output. Alternatively, some embodiments may include some or all of the context for a combined language model input. Some embodiments may provide some or all of the context to an external agent in cases where such context may be useful to maintain data tracking or output accuracy. For example, if an external agent includes a large language model, some embodiments may provide both a prompt and a context that includes data table column information and column values to the external agent, where an output of the external agent includes one or more column values.

In some embodiments, a framework or other system controlling different agents may route the output of one agent to one or more other agents to produce a final output used as a report value or otherwise used by a server system. For example, some embodiments may send a first prompt of a combined language model input to a framework in point, where a framework agent orchestrator may manage operations for a first external agent and a second external agent. The first external agent may perform a first set of operations to produce an intermediate output. The agent orchestrator may then perform operations to send the intermediate output to the second external agent as an input to produce a second output. The agent orchestrator may then send the second output to a server system for use as a report value or to otherwise use as a value for one or more operations described in this disclosure.

Some embodiments may search a set of data stores based on the set of queries to retrieve a first set of report values corresponding with the user-provided prompt and a set of other report values corresponding with the set of follow-up text sequences, as indicated by block 340. In some embodiments, operations for the block 340 may be performed by a server system, as indicated by column 301. The search may separate different results based on different queries or different prompts. For example, some embodiments may (1) infer a first query or related instructions (e.g., instructions to generate a report or other document from query results) based on a user-provided prompt, (2) retrieve a first set of report values or other output (e.g., a full report) by searching a set of databases or other data stores using this first query or related instructions, and (3) associate the first set of report values or other output with the user-provided prompt. Similarly, some embodiments may, for each respective predicted prompt, (1) infer a respective query or related instructions based on the respective predicted prompt, (2) retrieve a respective set of other report values or other output by searching a set of databases or other data stores using this respective query, and (3) associate the respective set of other report values or other output with the respective predicted prompt.

It should be understood that some embodiments may infer multiple queries based on a prompt. For example, some embodiments may configure an input context of a combined language model input to cause a language model to generate two different queries based on a single user-provided prompt and combine the results of the two different queries into one report document. In response, some embodiments may associate the report and the report values (produced by the use of the two different queries) with the user-provided prompt. Furthermore, it should be understood that a query may correspond with multiple prompts. For example, a user-provided text sequence representing a user-provided prompt and a predicted text sequence representing a predicted follow-up prompt may each cause a second query to be generated by a language model.

In some embodiments, a query may be structured to retrieve data from multiple databases. As described elsewhere, when inferring a set of queries, some embodiments may infer a cross-database query of the set of queries. Some embodiments may perform a search through an indicated set of databases or other data sources. In cases where one or more additional permissions are needed to access a data source, some embodiments may search through a stored set of authentication keys, passwords, tokens, etc. corresponding with the data source.

Some embodiments may evaluate a candidate query by determining a predicted computing resource utilization for the candidate query. For example, some embodiments may determine the utilization of a candidate SQL query generated by a language model by using an “EXPLAIN” or “EXPLAIN ANALYZE” for the candidate SQL query. Alternatively, or additionally, some embodiments may use a set of statistical functions determined from historical query performances or machine learning model trained on historical query performances to determine a utilization for a candidate query. In some embodiments, a predicted computing utilization may include a predicted number of processors to be used, a predicted processor running time, a predicted amount of memory to be used, a predicted amount of network resources to be used, predicted number of a specific type of processors to be used (e.g., a number of GPU, a number of TPU, etc.), a predicted amount of time for which one or more specific types of processors are to be used, etc. As described elsewhere in this disclosure, some embodiments may determine whether or not to pre-prepare generating reports or executing searches associated with predicted prompts based on whether or not a predicted computing resource utilization associated with a predicted prompt satisfies a set of thresholds.

Some embodiments may store the second set of report values in memory or later use, as indicated by block 344. In some embodiments, operations for the block 344 may be performed by a server system, as indicated by column 301. In some embodiments, the second set of report values may include one or more of the obtained report values described for operations described by block 340. Some embodiments may store the first set of report values or the second set of report values in a cache memory, where the cache memory is faster than a long-term storage memory. For example, the cache memory may include in-memory storage, and may include the use of a caching system such as Redis or Memcached. Some embodiments may cache data using a cloud computing service. Some embodiments may generate reports from the report values and store the generated reports in cache memory. By storing retrieved report values or generated reports in cache memory, some embodiments may provide report data during real time operations or near real-time operations.

As described elsewhere in this disclosure, some embodiments may send retrieved report values or corresponding reports generated from the report values to other computing systems that may then cache or otherwise store the data in a local data store. For example, some embodiments may send report values to a client device that then stores the in local memory system of the client device. The client device may then perform local operations to determine whether to present or hide the locally stored data.

Some embodiments may prioritize searches or not perform searches based on a ranking of importance for the queries used for the searches. For example, some embodiments may determine a computing resource that may be allocated for a set of searches based on queries inferred from a set of predicted prompts that includes a first prompt, a second prompt, and third prompt. Some embodiments may rank the likelihoods of the first, second, and third prompts as being equal to 50%, 20%, and 10%, respectively. Some embodiments may further determine that an available memory threshold is limited to the storage of search results based on queries inferred from predicted prompts. Some embodiments may then select queries inferred from the first prompt and the second prompt for performing search operations without performing a search based on the third prompt. It should be understood that other criteria may be used to perform a search or limit storage of data retrieved from a search. For example, such criteria may include limiting the storage of data to queries generated from prompts having a likelihood value that exceeds a minimum likelihood value, limiting the search to a specific amount of processor resources consumed, limiting a search to a room restricted set of databases or other types of data stores (e.g., searches involving queries that search through a restricted set of databases are not performed), etc.

Some embodiments predict a set of additional follow-up prompts based on the retrieved report values and the user-provided text sequence, as indicated by block 348. In some embodiments, operations for the block 348 may be performed by a server system, as indicated by column 301. Some embodiments may use a prompt prediction model that is trained to predict one or more prompts based on values already retrieved for presentation to a user. For example, some embodiments may perform one or more operations described for block 344 to retrieve a set of report values showing that values for a data column of a database is decreasing over time. Some embodiments may perform a set of processing operations on the retrieved set of report values to detect this trend or perform other processing operations based on the retrieved report values to determine other report-value-derived results. For example, some embodiments may compute a mean average of derivative values or differences between values over time. Some embodiments may then provide the set of report values or report-value-derived results to a prompt prediction model to obtain a set of predicted prompts. In some embodiments, this prompt prediction model may also use, as an input, the user-provided text sequence. For example, some embodiments may use a first prompt prediction model to determine additional follow-up prompt and provide this first prompt model with a set of retrieved report values and a user-provided prompt “tell me about data integrity.” In response, the first prompt prediction model may output a first additional follow-up prompt “tell me about data degradation trends.” Some embodiments may then provide this first prompt prediction model with the same set of retrieved report values and a user-provided prompt “tell me about data input.” In response, the first prompt prediction model may output the prompt “draw trends between data input and data quality.”

Some embodiments may determine whether to generate a set of additional follow-up prompts based on a preliminary assessment of whether a retrieved set of report values corresponding with the user-provided query satisfies a set of criteria. For example, some embodiments may determine whether the retrieved set of report values are all within a historic set of report value ranges, where the historic set of report value ranges may be characterized as a threshold boundary of a historic set of report values. In some embodiments, as described elsewhere in this disclosure, a predicted query may be associated with a defined set of report values. Some embodiments may then determine a result indicating that one or more values of a current set of retrieved report values (e.g., report values retrieved by performing operations described for block 340) exceeds one or more boundaries of a historic set of report value ranges. In response to determining the result, some embodiments may perform operations to generate additional queries. By being configured to generate additional queries based on whether a current set of retrieved report values are within a report value space boundary, some embodiments may prevent the unnecessary use of a language model, thereby conserving computing resources.

Later-obtained, user-provided prompt sufficiently matches a predicted prompt based in part on whether one or more retrieved reporting values satisfy a historic set of report value ranges determined based on a historic set of report values. In some embodiments, as described elsewhere in this disclosure, a predicted query may be associated with a defined set of report values. Some embodiments may then determine a historic set of report value ranges as a region in a report value parameter space that is within a threshold value of the defined set of report value ranges. Some embodiments may then determine that a later-provided prompt is sufficiently similar to a predicted prompt based on a determination that (1) the later-provided prompt is semantically similar to the predicted prompt and (2) a set of retrieved report values are within the defined set of report value ranges. For example, a server system may determine that a later-provided prompt is semantically similar to a predicted prompt by providing both prompts to a machine learning model that produces a similarity score output. The server system may then determine whether a first set of report values retrieved are all within a defined set of report value ranges characterized as being within 10% of a first set of report value ranges associated with the predicted prompt.

In some embodiments, the prompt prediction model used to determine the set of additional follow-up prompts using operations described for block 348 may be the same as the prompt prediction model used to determine the set of follow-up text to sequences using operations described for block 306. Alternatively, the two prediction models may be independent of each other.

Some embodiments may use a language model to output a second set of queries based on the set of additional follow-up prompts as described by operations described for block 352. In some embodiments, operations for the block 320 may be performed by a large language model system, as indicated by column 303. Some embodiments may perform operations similar to or the same as those described for block 320 when performing operations to output queries based on the set of additional follow-up prompts. In some embodiments, the language model used to produce the second set of queries may be similar to or the same as the model used to produce the set of queries described for block 320. Alternatively, the language model used to produce the second set of queries may be different from the model used to produce the set of queries described for block 320.

Furthermore, as described elsewhere in this disclosure, some embodiments may forgo performing one or more operations described in this disclosure without foregoing performing other operations described in this disclosure. For example, some embodiments may perform operations described for block 340 without performing operations described for block 348 or block 352.

Some embodiments may provide the first set of report values to the client device, as indicated by block 356. In some embodiments, operations for the block 360 may be performed by a server system, as indicated by column 301. Some embodiments may send the first set of report values without sending other report values. For example, some embodiments may send the first set of report values without sending the second set report values determined using operations described by block 352. Alternatively, some embodiments may send multiple sets of report values to the client system. For example, some embodiments may send the first set of report values, the second set report values, and other sets of report values, where the client device may store, present, hide, or delete report values as required based on client device operations.

Some embodiments may update a dashboard based on the first set of report values, as indicated by block 360. In some embodiments, operations for the block 360 may be performed by a client system, as indicated by column 302. In some embodiments, a server system may send a set of report values to a client computing device. For example, a client device may display a graph of report values, where receiving an updated set of report values may cause the client device to dynamically update the graph of report values or generate a new graph of report values.

In some embodiments, a client device may determine a set of dashboard parameters based on a received set of report values. As described elsewhere in this disclosure, dashboard parameters may control the presentation or movement of a dashboard or other user interface. In some embodiments, one or more dashboard parameters may be the same as one or more report values. For example, some embodiments may determine that a first set of dashboard parameters is equal to a first set of report values when using the first set of dashboard parameters in a bar graph. Alternatively, or additionally, some embodiments may transform one or more report values to produce one or more dashboard parameters. For example, some embodiments may normalize a set of report values by a maximum of the set of report values or a default maximum value to produce a set of dashboard parameters. Alternatively, or additionally, some embodiments may send report values to a client device and generate a resulting set of dashboard parameters.

Some embodiments may determine whether a pattern of a later-obtained interface interaction or values derived from the later-obtained interface interaction sufficiently matches a set of follow-up interface interaction values, as indicated by block 364. In some embodiments, operations for the block 364 may be performed by a client system, as indicated by column 302.

Some embodiments may determine whether a later-obtained text sequence representing a second user-provided prompt sufficiently matches a predicted follow-up text sequence or other prompt of the set of predicted follow-up prompts. In cases where the later-obtained prompt sufficiently matches a predicted follow-up prompt, some embodiments may determine the set of predicted follow-up prompts.

The determination of whether prompts sufficiently match may be based on a pattern of the prompts, keywords of the prompts, report values associated with the prompts, outputs of machine learning models comparing the prompts, similarity scores using embedding models, etc. For example, some embodiments may use a rules-based system to reduce a second prompt into a regular expression pattern and determine whether this regular expression pattern of the second prompt matches a candidate query. Alternatively, or additionally, some embodiments may provide the second prompt to an encoder neural network to transform the second prompt into a first embedding vector in an embedding space representing user intent. Some embodiments may perform similar operations on one or more predicted prompts to generate a set of predicted prompt embedding vectors. Some embodiments may then compare the set of predicted prompt embedding vectors of with the first embedding vector and, based on a determination that a distance in the embedding space between the first embedding vector and at least one prompt of the set of picking prompts is within a threshold, determine that the pair of prompts are sufficiently matching.

When a client device or other device obtains a second prompt, some embodiments may compare the second prompt with predicted prompts to determine whether or not to retrieve previously stored data. For example, a user may enter, into a text entry field displayed on a client device, a second user-provided text sequence representing a user-provided prompt. The client device may determine whether the user-provided text sequence sufficiently matches a predicted follow-up text sequence of the set of predicted follow-up text sequences using a rules-based system (e.g., a text matching system) or a machine learning model. Alternatively, or additionally, the client device may send the second user-provided text sequence to a server system that determines whether the second user-provided text sequence is one or more text sequences of the set of follow-up text sequences.

Some embodiments may determine whether a later-obtained, user-provided prompt (e.g., a later-obtained text sequence) sufficiently matches a predicted prompt based in part on whether one or more retrieved reporting values satisfy a historic set of report value ranges determined based on a historic set of report values. In some embodiments, as described elsewhere in this disclosure, a predicted query may be associated with a defined set of report values. Some embodiments may then determine a historic set of report value ranges as a region in a report value parameter space that is within a threshold value of the defined set of report value ranges. Some embodiments may then determine that a later-provided prompt is sufficiently similar to a predicted prompt based on a determination that (1) the later-provided prompt is semantically similar to the predicted prompt, and (2) a set of retrieved report values are within the defined set of report value ranges. For example, a server system may determine that a later-provided prompt is semantically similar to a predicted prompt by providing both prompts to a machine learning model that produces a similarity score output. The server system may then determine whether a first set of report values retrieved are all within a defined set of report value ranges characterized as being within 10% of a first set of report value ranges associated with the predicted prompt.

In response to a determination that the second user-provided prompt sufficiently matches a text sequence of a set of predicted follow-up text sequences, some embodiments proceed to operations described for block 370. Otherwise, operations may return to operations described for block 304.

Some embodiments may retrieve one or more other report values from the memory used to store the retrieved set of other report values or related data, as indicated by block 370. In some embodiments, a server system may store a set of other report values or reports generated from this set of other report values in association with one or more predicted prompts. After receiving an indication that a user-provided prompt is sufficiently similar to the predicted prompt, some embodiments may retrieve this set of other report values or the report generated from the set of other report values. As described elsewhere in this disclosure, some embodiments may use a server system to retrieve the data from a memory of the server system. Alternatively, or additionally, some embodiments may use a client device to retrieve the data from a local memory of the client device. As described elsewhere, the preliminary prediction model may be a rules-based prediction model, a statistical model, or a machine learning model. For example, the preliminary prediction model may include a transformer-based neural network that outputs a set of predicted prompts after being provided with a first prompt.

Some embodiments may present the one or more other report values on the client device, as indicated by block 374. Some embodiments may perform operations similar to or the same as those described for block 360 to present the one or more other report values on the client device. Some embodiments may update an audio or visual dashboard to present audio or visual content in the audio or visual dashboard. In some embodiments, the changes may relate to a change of an audio component or a visual component of the audio or visual dashboard. For example, some embodiments may update a dashboard component such as a dashboard graph or other visualization of data based on a received set of report values retrieved from a cache.

It should be understood that any assignment of an operation to a particular component or system is not restricted to that component or system unless specified as being exclusively limited to that system. For example, while a server system may perform operations of column 302 as indicated in the process 300, one or more operations described as being performed in column 302 may be performed instead by a client system or other computing system.

The above-described embodiments of the present disclosure are presented for purposes of illustration and not of limitation, and the present disclosure is limited only by the claims which follow. Furthermore, it should be noted that the features and limitations described in any embodiment may be applied to one or more other embodiments herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods. Furthermore, not all operations of a flowchart need to be performed. In addition, the systems and methods described herein may be performed in real time. It should also be noted that the systems and/or methods described above may be applied to, or used in accordance with, other systems and/or methods.

Furthermore, the computing devices described in this disclosure may be any type of computing device unless otherwise stated, including, but not limited to, a laptop computer, a tablet computer, a hand-held computer, and/or other computing equipment (e.g., a server), including “smart,” wireless, wearable, and/or mobile devices. For example, the client device 102 of FIG. 1 may be a smartphone, another type of mobile computing device, or a payment terminal. Furthermore, the embodiments described in this disclosure may include an individual device that performs some or all the operations described in this disclosure. Alternatively, other embodiments may include multiple computing devices acting collectively to perform some or all the operations described in this disclosure.

As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety (i.e., the entire portion), of a given item (e.g., data) unless the context clearly dictates otherwise. Furthermore, a “set” may refer to a singular form or a plural form, such that a “set of items” may refer to one item or a plurality of items.

In some embodiments, the operations described in this disclosure may be implemented in a set of processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on one or more non-transitory machine-readable media (e.g., a set of machine-readable storage media), such as an electronic storage medium. Furthermore, the use of the term “media” may include a single medium or combination of multiple media, such as a first medium and a second medium. A set of non-transitory machine-readable media storing instructions may include instructions included on a single medium or instructions distributed across multiple media. The processing devices may include one or more devices configured through hardware, firmware, and/or software to be specifically designed for the execution of one or more of the operations of the methods.

In some embodiments, the various computer systems and subsystems illustrated in FIG. 1 or FIG. 2 may include one or more computing devices that are programmed to perform the functions described herein. The computing devices may include one or more electronic storages (e.g., a set of databases accessible to one or more applications depicted in the system 100), one or more physical processors programmed with one or more computer program instructions, and/or other components. For example, the set of databases may include a relational database. Alternatively, or additionally, the set of databases or other electronic storage used in this disclosure may include a non-relational database.

The computing devices may include communication lines or ports to enable the exchange of information with a set of networks (e.g., a network used by the system 100) or other computing platforms via wired or wireless techniques. The network may include the internet, a mobile phone network, a mobile voice or data network (e.g., a 5G or Long-Term Evolution (LTE) network), a cable network, a public switched telephone network, or other types of communication networks or combination of communication networks. A network described by devices or systems described in this disclosure may include one or more communications paths, such as Ethernet, a satellite path, a fiber-optic path, a cable path, a path that supports internet communications (e.g., IPTV), free-space connections (e.g., for broadcast or other wireless signals), Wi-Fi, Bluetooth, near field communication, or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Each of these devices described in this disclosure may also include electronic storages. The electronic storages may include non-transitory storage media that electronically stores information. The storage media of the electronic storages may include one or both of: (i) system storage that is provided integrally (e.g., substantially non-removable) with servers or client computing devices, or (ii) removable storage that is removably connectable to the servers or client computing devices via port (e.g., a USB port, a firewire port, etc.) or drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). An electronic storage may store software algorithms, information determined by the processors, information obtained from servers, information obtained from client computing devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent the processing functionality of a plurality of devices operating in coordination. The processors may be programmed to execute computer program instructions to perform functions described herein of subsystems described in this disclosure or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems described herein is for illustrative purposes, and is not intended to be limiting, as any of the subsystems described in this disclosure may provide more or less functionality than is described. For example, one or more of subsystems described in this disclosure may be eliminated, and some or all of its functionality may be provided by other ones of subsystems described in this disclosure. As another example, additional subsystems may be programmed to perform some or all of the functionality attributed herein to one of the subsystems described in this disclosure.

With respect to the components of computing devices described in this disclosure, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Further, some or all of the computing devices described in this disclosure may include a user input interface and/or user output interface (e.g., a display) for use in receiving and displaying data. In some embodiments, a display such as a touchscreen may also act as a user input interface. It should be noted that in some embodiments, one or more devices described in this disclosure may have neither user input interface nor displays and may instead receive and display content using another device (e.g., a dedicated display device such as a computer screen and/or a dedicated input device such as a remote control, mouse, voice input, etc.). Additionally, one or more of the devices described in this disclosure may run an application (or another suitable program) that performs one or more operations described in this disclosure.

Although the present invention has been described in detail for the purpose of illustration based on what is currently considered to be the most practical and preferred embodiments, it is to be understood that such detail is solely for that purpose and that the invention is not limited to the disclosed embodiments but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

As used throughout this application, the word “may” is used in a permissive sense (i.e., meaning having the potential to), rather than a mandatory sense (i.e., meaning must). The words “include,” “including,” “includes,” and the like mean including, but not limited to. As used throughout this application, the singular forms “a,” “an,” and “the” include plural referents unless the context clearly indicates otherwise. Thus, for example, reference to “an element” or “the element” includes a combination of two or more elements, notwithstanding the use of other terms and phrases for one or more elements, such as “one or more.” The term “or” is non-exclusive (i.e., encompassing both “and” and “or”), unless the context clearly indicates otherwise. Terms describing conditional relationships (e.g., “in response to X, Y,” “upon X, Y,” “if X, Y,” “when X, Y,” and the like) encompass causal relationships in which the antecedent is a necessary causal condition, the antecedent is a sufficient causal condition, or the antecedent is a contributory causal condition of the consequent (e.g., “state X occurs upon condition Y obtaining” is generic to “X occurs solely upon Y” and “X occurs upon Y and Z”). Such conditional relationships are not limited to consequences that instantly follow the antecedent obtaining, as some consequences may be delayed, and in conditional statements, antecedents are connected to their consequents (e.g., the antecedent is relevant to the likelihood of the consequent occurring). Statements in which a plurality of attributes or functions are mapped to a plurality of objects (e.g., a set of processors performing steps/operations A, B, C, and D) encompass all such attributes or functions being mapped to all such objects and subsets of the attributes or functions being mapped to subsets of the attributes or functions (e.g., both/all processors each performing steps/operations A-D, and a case in which processor 1 performs step/operation A, processor 2 performs step/operation B and part of step/operation C, and processor 3 performs part of step/operation C and step/operation D), unless otherwise indicated. Further, unless otherwise indicated, statements that one value or action is “based on” another condition or value encompass both instances in which the condition or value is the sole factor and instances in which the condition or value is one factor among a plurality of factors.

Unless the context clearly indicates otherwise, statements that “each” instance of some collection has some property should not be read to exclude cases where some otherwise identical or similar members of a larger collection do not have the property (i.e., each does not necessarily mean each and every). Limitations as to the sequence of recited steps should not be read into the claims unless explicitly specified (e.g., with explicit language like “after performing X, performing Y”) in contrast to statements that might be improperly argued to imply sequence limitations (e.g., “performing X on items, performing Y on the X'ed items”) used for purposes of making claims more readable rather than specifying a sequence. Statements referring to “at least Z of A, B, and C,” and the like (e.g., “at least Z of A, B, or C”), refer to at least Z of the listed categories (A, B, and C) and do not require at least Z units in each category. Unless the context clearly indicates otherwise, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. Furthermore, unless indicated otherwise, updating an item may include generating the item or modifying an existing item. Thus, updating a record may include generating a record or modifying the value of an already-generated value in a record. Additionally, as used in the specification, “a portion” refers to a part of, or the entirety of (i.e., the entire portion), a given item (e.g., data) unless the context clearly dictates otherwise.

Unless the context clearly indicates otherwise, ordinal numbers used to denote an item do not define the item's position. For example, an item that may be a first item of a set of items even if the item is not the first item to have been added to the set of items or is otherwise indicated to be listed as the first item of an ordering of the set of items. Thus, for example, if a set of items is sorted in a sequence from “item 1,” “item 2,” and “item 3,” a first item of a set of items may be “item 2” unless otherwise stated.

### Enumerated Embodiments

The present techniques will be better understood with reference to the following enumerated embodiments:
1. A method comprising: generating a model input comprising a representation of a first interface interaction value and a set of follow-up interface interaction values that is predicted based on the first interface interaction value; obtaining a set of queries for a set of databases by providing, to a machine learning model, the model input, wherein the set of queries comprises a first query associated with the first interface interaction value and a second query associated with at least one value of the set of follow-up interface interaction values; updating a dashboard or other interface to present at least one value of the first set of report values; and updating the dashboard by obtaining the second set of report values.
2. A method comprising: generating a model input comprising a representation of a first interface interaction value and a set of follow-up interface interaction values that is predicted based on the first interface interaction value; obtaining a set of queries for a set of databases by providing, to a machine learning model, the model input, wherein the set of queries comprises a first query associated with the first interface interaction value and a second query associated with the set of follow-up interface interaction values; storing a second set of report values in an in-memory storage by searching a data store using the set of queries to obtain a first set of report values and the second set of report values; updating a dashboard or other interface presented on a client device to present at least one value of the first set of report values by providing, to the client device, the first set of report values; and in response to matching a pattern of a later-obtained interface interaction with at least one interaction of the set of follow-up interface interaction values, updating the dashboard or other interface by causing the client device to obtain the second set of report values stored in the in-memory storage.
3. A method comprising: generating a model input comprising a representation of a first interface interaction value and a set of follow-up interface interaction values that is predicted based on the first interface interaction value; obtaining a set of queries for a set of databases by providing, to a machine learning model, the model input, wherein the set of queries comprises a first query associated with the first interface interaction value and a second query associated with the set of follow-up interface interaction values; storing a second set of report values in an in-memory storage by searching a data store using the set of queries to obtain a first set of report values and the second set of report values; updating a dashboard or other interface presented on a client device to present at least one value of the first set of report values by providing, to the client device, the first set of report values; and in response to matching a pattern of a later-obtained interface interaction with at least one interaction of the set of follow-up interface interaction values, updating the dashboard or other interface by causing the client device to obtain the second set of report values stored in the in-memory storage.
4. A method comprising: generating, with a server, a combined language model input comprising a user-provided text sequence obtained from a client device and a predicted language model context comprising a set of follow-up text sequences representing anticipated input text generated by a preliminary prediction model; inferring a set of queries for a set of databases by providing the combined language model input to a language model in a single pass via a network application programming interface, the set of queries comprising a first query and a second query; storing, in in-memory storage, first report values and second report values by searching a data store using the set of queries to obtain the first report values for a first report based on the first query and the second report values for a second report based on the second query; updating an audio or visual dashboard or other interface to present audio or visual content corresponding to the first report values by providing, to the client device, the first report values; and in response to matching a pattern of a later-obtained text sequence to at least one sequence of the set of follow-up text sequences, updating the audio or visual dashboard or other interface to present audio or visual content corresponding to the second report values by causing the client device to obtain the second report values stored in the in-memory storage.
5. A method comprising: generating a combined language model input comprising a first interface interaction value and a language model context comprising a set of follow-up interface interaction values generated by a preliminary prediction model; inferring a set of queries for a set of databases by providing the combined language model input to a language model, the set of queries comprising a first query associated with the first interface interaction value and a second query associated with the set of follow-up interface interaction values; searching a data store based on the set of queries to obtain a first set of report values based on the first query and a second set of report values based on the second query; storing the second set of report values in a cache; updating a rendering of a dashboard or other interface to present at least one value of the first set of report values by providing, to a client device, the first set of report values; determining a result indicating that a pattern of a later-obtained interface interaction matches at least one of the set of follow-up interface interaction values; and in response to a determination of the result, updating the rendering of the dashboard or other interface to present the second set of report values by causing the client device to obtain the second set of report values stored in the cache.
6. A method of any of the embodiments above, wherein the result is a first result, and wherein searching the data store based on the set of queries comprises: searching the data store based on the first query; determining a predicted computing resource utilization for the second query; determining a second result indicating that the predicted computing resource utilization satisfies a threshold; and searching the data store based on the second query in response to the second result.
7. A method of any of the embodiments above, wherein the set of queries is a first set of queries, and wherein the combined language model input is a first combined language model input, further comprising: obtaining a second set of queries by providing, to the language model, a second combined language model input comprising the first interface interaction value and the first set of report values; retrieving a third set of report values by searching the data store using the second set of queries; and updating the dashboard to present the third set of report values.
8. A method of any of the embodiments above, further comprising retraining the preliminary prediction model to output at least one query of the second set of queries based on the first interface interaction value.
9. A method of any of the embodiments above, wherein the result is a first result, and wherein providing the second combined language model input to the language model comprises: retrieving a historic set of report value ranges associated with the preliminary prediction model; determining a second result indicating that the first set of report values exceeds a set of thresholds indicated by the historic set of report value ranges; and providing the second combined language model input to the language model based on the second result.
10. A method of any of the embodiments above, wherein inferring the set of queries comprises inferring a cross-database query of the set of queries.
11. A method of any of the embodiments above, wherein the set of follow-up interface interaction values comprises a first prompt for an external agent that is independent of the data store, further comprising: obtaining an external agent-provided output by providing the first prompt to the external agent; determining an agent-provided report value based on the external agent-provided output, wherein updating the dashboard to present the first set of report values comprises updating the dashboard to present the agent-provided report value.
12. A method of any of the embodiments above, wherein providing the first prompt to the external agent comprises providing the language model context and the first prompt to the external agent.
13. A method of any of the embodiments above, wherein the external agent is a first external agent, and wherein the external agent-provided output is a first external agent-provided output, and wherein determining the agent-provided report value comprises: obtaining a second external agent-provided output by providing the external agent-provided output to a second external agent; and determining the agent-provided report value based on the second external agent-provided output.
14. A method of any of the embodiments above, wherein the set of follow-up interface interaction values comprises two different text sequences.
15. A method of any of the embodiments above, wherein each respective text sequence of the set of follow-up interface interaction values is separated from other text sequences of the set of follow-up interface interaction values by a delimiter.
16. A method of any of the embodiments above, further comprising: detecting that the first interface interaction value is provided by a first user; and configuring model parameters of a preliminary prediction model based on values of a user profile record for the first user; and determining the set of follow-up interface interaction values based on the first interface interaction value.
17. A method of any of the embodiments above, wherein the first set of report values corresponds with a first report, the second set of report values corresponds with a second report, and wherein: searching the data store using the set of queries comprises searching the data store to obtain a third set of report values corresponding with a third report, and storing the second set of report values in the in-memory storage comprises storing the third set of report values in the in-memory storage.
18. A method of any of the embodiments above, further comprising determining an available memory amount, wherein searching the data store comprises ranking the set of queries based on an associated set of likelihood scores.
19. A method of any of the embodiments above, wherein the set of queries is a first set of queries, and wherein the model input is a first model input, further comprising: obtaining a second set of queries by providing, to the machine learning model, a second model input comprising the first interface interaction value and the first set of report values; and updating the dashboard to present a third set of report values obtained from the set of databases by using the second set of queries.
20. A method of any of the embodiments above, wherein the set of follow-up interface interaction values comprises a first prompt for an external agent that is independent of the data store, further comprising: obtaining an external agent-provided output by providing the first prompt to the external agent; determining an agent-provided report value based on the external agent-provided output; and updating the dashboard to present the agent-provided report value.
21. A method of any of the embodiments above, wherein searching the data store based on the set of queries comprises: determining a predicted computing resource utilization for a candidate query of the set of queries; determining a second result indicating that the predicted computing resource utilization satisfies a threshold; and searching the data store based on the candidate query in response to the second result.
22. A method of any of the embodiments above, wherein inferring the set of queries comprises inferring a cross-database query of the set of queries.
23. A tangible, non-transitory machine-readable medium storing instructions that, when executed by a data processing apparatus, cause the data processing apparatus to perform operations comprising those of any of embodiments 1-22.
24. A system comprising one or more processors; and memory storing instructions that, when executed by the processors, cause the processors to effectuate operations comprising those of any of embodiments 1-22.
25. A system comprising means for performing any of embodiments 1-22.

1. A system for reducing network resource consumption when generating interactive audio/visual dashboard content by using a predicted language model context, comprising one or more non-transitory media storing program instructions that, when executed by one or more processors, causes the one or more processors to perform operations comprising:
generating, with a server, using a preliminary prediction model, and for a large language model (LLM), a combined language model input comprising prompt obtained from a client device and a predicted language model context comprising a set of follow-up prompts, generated by the preliminary prediction model, that represent one or more anticipated future prompts that are likely to be provided after receiving a response, to the prompt. from the LLM ;
inferring, using the LLM, a set of queries for a set of databases by providing the combined language model input to the LLM in a single pass, via a network application programming interface, to reduce the network resource consumption, the set of queries comprising a first query and a second query;
storing, in in-memory storage, first report values and second report values by searching a data store using the set of queries to obtain the first report values for a first report based on the first query and the second report values for a second report based on the second query;
updating an audio or visual dashboard to present audio or visual content corresponding to the first report values by providing, to the client device, the first report values; and
in response to matching a pattern of a later-obtained text sequence to at least one sequence of the set of follow-up text sequences, updating the audio or visual dashboard to present audio or visual content corresponding to the second report values by causing the client device to obtain the second report values stored in the in-memory storage.

2. A method for reducing network resource consumption by using a predicted language model context, comprising:
generating, using a preliminary prediction model and for a language model, a combined language model input comprising a first interface interaction value and a language model context comprising a set of follow-up interface interaction values, generated by the preliminary prediction model, that correspond to one or more anticipated future prompts that are likely to be provided after receiving a response, to the prompt, from the language model;
inferring, using the language model, a set of queries for a set of databases by providing the combined language model input to the language model in a single message or in a single pass to reduce the network resource consumption, the set of queries comprising a first query associated with the first interface interaction value and a second query associated with the set of follow-up interface interaction values;
searching a data store based on the set of queries to obtain a first set of report values based on the first query and a second set of report values based on the second query;
storing the second set of report values in a cache;
updating a rendering of a dashboard to present at least one value of the first set of report values by providing, to a client device, the first set of report values;
determining a result indicating that a pattern of a later-obtained interface interaction matches at least one of the set of follow-up interface interaction values; and
in response to a determination of the result, updating the rendering of the dashboard to present the second set of report values by causing the client device to obtain the second set of report values stored in the cache.

3. The method of claim 2, wherein the result is a first result, and wherein searching the data store based on the set of queries comprises:
searching the data store based on the first query;
determining a predicted computing resource utilization for the second query;
determining a second result indicating that the predicted computing resource utilization satisfies a threshold; and
searching the data store based on the second query in response to the second result.

4. The method of claim 2, wherein the set of queries is a first set of queries, and wherein the combined language model input is a first combined language model input, further comprising:
obtaining a second set of queries by providing, to the language model, a second combined language model input comprising the first interface interaction value and the first set of report values;
retrieving a third set of report values by searching the data store using the second set of queries; and
updating the dashboard to present the third set of report values.

5. The method of claim 4, further comprising retraining the preliminary prediction model to output at least one query of the second set of queries based on the first interface interaction value.

6. The method of claim 4, wherein the result is a first result, and wherein providing the second combined language model input to the language model comprises:
retrieving a historic set of report value ranges associated with the preliminary prediction model;
determining a second result indicating that the first set of report values exceeds a set of thresholds indicated by the historic set of report value ranges; and
providing the second combined language model input to the language model based on the second result.

7. The method of claim 2, wherein inferring the set of queries comprises inferring a cross-database query of the set of queries.

8. The method of claim 2, wherein the set of follow-up interface interaction values comprises a first prompt for an external agent that is independent of the data store, further comprising:
obtaining an external agent-provided output by providing the first prompt to the external agent; and
determining an agent-provided report value based on the external agent-provided output, wherein updating the dashboard to present the first set of report values comprises updating the dashboard to present the agent-provided report value.

9. The method of claim 8, wherein providing the first prompt to the external agent comprises providing the language model context and the first prompt to the external agent.

10. The method of claim 8, wherein the external agent is a first external agent, and wherein the external agent-provided output is a first external agent-provided output, and wherein determining the agent-provided report value comprises:
obtaining a second external agent-provided output by providing the external agent-provided output to a second external agent; and
determining the agent-provided report value based on the second external agent-provided output.

11. The method of claim 2, wherein the set of follow-up interface interaction values comprises two different text sequences.

12. One or more non-transitory machine-readable media storing program instructions that, when executed by one or more processors, causes the one or more processors to perform operations comprising:
generating, using a preliminary prediction model and for a machine learning model, a model input comprising a representation of a first interface interaction value and a set of follow-up interface interaction values generated by the preliminary prediction model, that represent one or more anticipated future prompts that are likely to be provided after receiving a response, to the prompt, from the machine learning model;
obtaining, using the machine learning model, a set of queries for a set of databases by providing, to the machine learning model, the model input in a single message or in a single pass to reduce the network resource consumption, wherein the set of queries comprises a first query associated with the first interface interaction value and a second query associated with the set of follow-up interface interaction values;
storing a second set of report values in an in-memory storage by searching a data store using the set of queries to obtain a first set of report values and the second set of report values;
updating an interactive interface presented on a client device to present at least one value of the first set of report values by providing, to the client device, the first set of report values; and
in response to matching a pattern of a later-obtained interface interaction with at least one interaction of the set of follow-up interface interaction values, updating the interactive interface by causing the client device to obtain the second set of report values stored in the in-memory storage.

13. The one or more non-transitory machine-readable media of claim 12, wherein each respective text sequence of the set of follow-up interface interaction values is separated from other text sequences of the set of follow-up interface interaction values by a delimiter.

14. The one or more non-transitory machine-readable media of claim 12, the operations further comprising:
detecting that the first interface interaction value is provided by a first user;
configuring model parameters of a preliminary prediction model based on values of a user profile record for the first user; and
determining the set of follow-up interface interaction values based on the first interface interaction value.

15. The one or more non-transitory machine-readable media of claim 12, wherein the first set of report values corresponds with a first report, the second set of report values corresponds with a second report, and wherein:
searching the data store using the set of queries comprises searching the data store to obtain a third set of report values corresponding with a third report, and
storing the second set of report values in the in-memory storage comprises storing the third set of report values in the in-memory storage.

16. The one or more non-transitory machine-readable media of claim 12, further comprising determining an available memory amount, wherein searching the data store comprises ranking the set of queries based on an associated set of likelihood scores.

17. The one or more non-transitory machine-readable media of claim 12, wherein the set of queries is a first set of queries, and wherein the model input is a first model input, further comprising:
obtaining a second set of queries by providing, to the machine learning model, a second model input comprising the first interface interaction value and the first set of report values; and
updating the interactive interface to present a third set of report values obtained from the set of databases by using the second set of queries.

18. The one or more non-transitory machine-readable media of claim 12, wherein the set of follow-up interface interaction values comprises a first prompt for an external agent that is independent of the data store, further comprising:
obtaining an external agent-provided output by providing the first prompt to the external agent; and
determining an agent-provided report value based on the external agent-provided output; and updating the interactive interface to present the agent-provided report value.

19. The one or more non-transitory machine-readable media of claim 12, wherein searching the data store based on the set of queries comprises:
determining a predicted computing resource utilization for a candidate query of the set of queries;
determining a second result indicating that the predicted computing resource utilization satisfies a threshold; and
searching the data store based on the candidate query in response to the second result.

20. The one or more non-transitory machine-readable media of claim 12, wherein inferring the set of queries comprises inferring a cross-database query of the set of queries.
